(19) United States
(12) Patent Application Publication
(10) Pub. No.: US 2023/0090327 A1
(43) Pub. Date: Mar. 23, 2023

(54) METHODS FOR PREPARING MIXED POLYAMIDES, POLYIMIDES AND POLYAMIDEIMIDES VIA HYDROTHERMAL POLYMERIZATION

(71) Applicant: ExxonMobil Technology and Engineering Company, Annandale, NJ (US)

(72) Inventors: Abhimanyu O. Patil, Westfield, NJ (US); Satish Bodige, Wayne, NJ (US); August W. Bosse, Pennington, NJ (US); Ozcan Altintas, Franklin Park, NJ (US)

(21) Appl. No.: 17/790,592

(22) PCT Filed: Dec. 30, 2020
(86) PCT No.: PCT/US2020/067398

§ 371 Date: Jul. 1, 2022

Related U.S. Application Data
(60) Provisional application No. 62/958,751, filed on Jan. 9, 2020.

(51) Int. Cl. C08G 73/14; C08G 73/10

(52) U.S. Cl. CPC C08G 73/14; C08G 73/1067

(57) ABSTRACT

Methods for preparing mixed polyamides, polyimides and polyamideimides under hydrothermal polymerization conditions are provided. The methods are based on suitable mixtures of poly carboxylic acids, poly carboxylic dianhydrides or poly carboxylic acid chloride anhydrides and polyamines and provide routes to low cost structural polymers useful in, for example, infrastructure applications.

### FIELD OF THE INVENTION

This disclosure relates to methods for preparing mixed polyamides, mixed polyimides and mixed polyamideimides under hydrothermal polymerization conditions. The methods utilize suitable mixtures of polycarboxylic acids, polycarboxylic acid chlorides, polycarboxylic dianhydrides or polycarboxylic acid chloride anhydrides and polyamines and provide routes to low cost structural polymers useful in, for example, infrastructure applications.

### BACKGROUND OF THE INVENTION

Polyamides and polyimides are important high-performance polymers because of their excellent thermal, mechanical, and chemical properties. Aromatic polyamide fibers, prepared by liquid-crystal spinning, and films have a large number of applications in modern industry. Linear aromatic polyimides are among the most thermally stable polymers to date, and they are useful for specialty applications in, for example, the microelectronics and aerospace industries.

Polyamides are typically produced either by the reaction of a dicarboxylic acid with a diamine or by ring-opening polymerization of lactams. Typically, the polymerizations are performed in solution or melt phase, through condensation to form low molecular weight polyamide followed by post-condensation in the solid phase to increase viscosity. Post-condensation temperatures may be in the range 200-250° C.

The classical synthesis of aromatic polyimides involves a condensation reaction between aromatic dianhydrides and aromatic diamines using high-boiling and toxic solvents, catalysts and high temperatures, which often imposes technical challenges in practical applications. The formation of polyimides from their building blocks is essentially irreversible, and often, the high chemical stability makes the polyimide neither soluble nor fusible with other materials. Therefore, two-step casting and imidizing of the polyamic acid intermediate is required.

Polyamideimides are typically made from condensation of diamines with carboxylic acid chloride anhydrides.

The term “hydrothermal” refers to temperatures above the boiling point of water and the corresponding autogenous pressures that arise in a closed vessel. Hydrothermal polymerization (HTP) is a benign and inherently green synthetic approach to synthesize high performance polymers in nothing but high-temperature water (HTW).

In view of the projected future decrease in hydrocarbon demand for transportation fuels there is a desire to identify alternative uses for hydrocarbon streams derived from crude oil. It would be useful to develop general methods for utilizing mixtures of hydrocarbon molecules derived from crude to prepare mixed structural polymers. This could lower the cost of manufacture and make such polymers accessible to less demanding infrastructure applications and other high volume products.

Furthermore, it would be desirable to identify methods of polyamide and polyimide synthesis that avoids toxic solvents and catalysts.

The present disclosures addresses, at least in part, these desires.

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

### SUMMARY OF THE INVENTION

The present disclosure is directed to a method for preparing a polymer, said polymer being selected from the group consisting of mixed polyamide, mixed polyimide and mixed polyamideimide, the method comprising:
(a) contacting two or more polycarboxylic acids, polycarboxylic acid chlorides or mixed polycarboxylic acids/acid chlorides, two or more polycarboxylic acid anhydrides, or two or more polycarboxylic acid chloride anhydrides, with one or more polyamines; or
(b) contacting two or more polyamines with one or more polycarboxylic acids, polycarboxylic acid chlorides or mixed polycarboxylic acids/acid chlorides, one or more polycarboxylic acid anhydrides, or one or more polycarboxylic acid chloride anhydrides; or
(c) contacting two or more polycarboxylic acids, polycarboxylic acid chlorides or mixed polycarboxylic acids/acid chlorides, two or more polycarboxylic acid anhydrides, or two or more polycarboxylic acid chloride anhydrides, with two or more polyamines;
   wherein the contacting occurs under hydrothermal conditions effective to form a mixed polyamide, mixed polyimide or mixed polyamideimide; and
   wherein, independently, the two or more polycarboxylic acids, polycarboxylic acid chlorides or mixed polycarboxylic acids/acid chlorides, two or more polycarboxylic acid anhydrides, two or more polycarboxylic acid chloride anhydrides, or two or more polyamines, have different molecular formulae or are structural isomers.

In some embodiments the polycarboxylic acids, polycarboxylic acid chlorides, mixed polycarboxylic acids/acid chlorides, polycarboxylic acid anhydrides or polycarboxylic acid chloride anhydrides are aromatic polycarboxylic acids, aromatic polycarboxylic acid chlorides aromatic mixed polycarboxylic acids/acid chlorides, aromatic polycarboxylic acid anhydrides or aromatic polycarboxylic acid chloride anhydrides.

In some embodiments the polyamines are aromatic polyamines.

In one embodiment the polymer is a mixed polyamide and the method comprises:
(a) contacting two or more polycarboxylic acids, polycarboxylic acid chlorides or mixed polycarboxylic acids/acid chlorides, with one or more polyamines; or
(b) contacting two or more polyamines with one or more polycarboxylic acids, polycarboxylic acid chlorides or mixed polycarboxylic acids/acid chlorides; or
(c) contacting two or more polycarboxylic acids, polycarboxylic acid chlorides or mixed polycarboxylic acids/acid chlorides, with two or polyamines;
   wherein the contacting occurs under hydrothermal conditions effective to form the mixed polyamide; and
   wherein, independently, the two or more polycarboxylic acids, polycarboxylic acid chlorides or mixed polycarboxylic acids/acid chlorides, or the two or more polyamines, have different molecular formulae or are structural isomers.

In some embodiments of the method of preparing a mixed polyamide the polycarboxylic acids are dicarboxylic acids.

In some embodiments of the method of preparing a mixed polyamide the polycarboxylic acid chlorides are dicarboxylic acid chlorides.

In some embodiments of the method of preparing a mixed polyamide the mixed polycarboxylic acids/acid chlorides are mixed dicarboxylic acids/acid chlorides.

In some embodiments of the method of preparing a mixed polyamide the polyamines are diamines.

In preferred embodiments of the method of preparing a mixed polyamide the polycarboxylic acids are dicarboxylic acids and the polyamines are diamines.

In another embodiment the polymer is a mixed polyimide and the method comprises:
(a) contacting two or more polycarboxylic acid anhydrides with one or more polyamines; or
(b) contacting two or more polyamines with one or more polycarboxylic acid anhydrides; or
(c) contacting two or more polycarboxylic acid anhydrides with two or more polyamines;
   wherein the contacting occurs under hydrothermal conditions effective to form the mixed polyimide; and
   wherein, independently, the two or more polycarboxylic acid anhydrides, or the two or more polyamines, have different molecular formulae or are structural isomers.

In some embodiments of the method of preparing a mixed polyimide the polycarboxylic acid anhydrides are tetracarboxylic acid dianhydrides.

In some embodiments of the method of preparing a mixed polyimide the polyamines are diamines.

In preferred embodiments of the method of preparing a mixed polyimide the polycarboxylic acid anhydrides are tetracarboxylic acid dianhydrides and the polyamines are diamines.

In another embodiment the polymer is a mixed polyamideimide and the method comprises:
(a) contacting two or more polycarboxylic acid chloride anhydrides with one or more polyamines; or
(b) contacting two or more polyamines with one or more polycarboxylic acid chloride anhydrides; or
(c) contacting two or more polycarboxylic acid chloride anhydrides with two or more polyamines;
   wherein the contacting occurs under hydrothermal conditions effective to form the mixed polyamideimide; and
   wherein, independently, the two or more polycarboxylic acid chloride anhydrides, or the two or more polyamines, have different molecular formulae or are structural isomers.

In some embodiments of the method of preparing a mixed polyamideimide the polycarboxylic acid chloride anhydrides are dicarboxylic acid chloride anhydrides.

In some embodiments of the method of preparing a mixed polyamideimide the polyamines are diamines.

In preferred embodiments of the method of preparing a mixed polyamideimide the polycarboxylic acid chloride anhydrides are dicarboxylic acid chloride anhydrides and the polyamines are diamines.

An advantage of the presently disclosed methods is that, unlike conventional synthetic approaches which often utilize toxic solvents and catalysts, hydrothermal polymerization is performed in water.

Another advantage of the presently disclosed methods is that low cost feedstock comprising mixtures of reactants, either as structurally different molecules or as different isomers, may be utilized. This potentially provides a route to the use of polyamides, polyimides or polyamideimides in high volume commodity products, such as products for infrastructure application.

In any one of the herein disclosed methods the two or more polycarboxylic acids are structural isomers.

In any one of the herein disclosed methods the two or more polycarboxylic acids have different molecular formulae.

In any one of the herein disclosed methods the two or more polycarboxylic acid chlorides are structural isomers.

In any one of the herein disclosed methods the two or more polycarboxylic acid chlorides have different molecular formulae.

In any one of the herein disclosed methods the two or more mixed polycarboxylic acids/acid chlorides have different molecular formulae.

In any one of the herein disclosed methods the two or more mixed polycarboxylic acids/acid chlorides are structural isomers.

In any one of the herein disclosed methods the two or more polycarboxylic acid anhydrides are structural isomers.

In any one of the herein disclosed methods the two or more polycarboxylic acid anhydrides have different molecular formulae.

In any one of the herein disclosed methods the two or more polycarboxylic acid chloride anhydrides are structural isomers.

In any one of the herein disclosed methods the two or more polycarboxylic acid chloride anhydrides have different molecular formulae.

In any one of the herein disclosed methods the two or more polyamines are structural isomers.

In any one of the herein disclosed methods the two or more polyamines have different molecular formulae.

In any one of the herein disclosed methods the two or more polyamines are not structural isomers of phenylene diamine.

In any one of the herein disclosed methods the mixed polyamide is a linear mixed polyamide.

In any one of the herein disclosed methods the mixed polyamide is a crosslinked mixed polyamide.

In any one of the herein disclosed methods the mixed polyimide is a linear mixed polyimide.

In any one of the herein disclosed methods the mixed polyimide is a crosslinked mixed polyimide.

In any one of the herein disclosed methods the mixed polyamideimide is a linear mixed polyamideimide.

In any one of the herein disclosed methods the mixed polyamideimide is a cross-linked mixed polyamideimide.

In any one of the herein disclosed embodiments the polycarboxylic acid has the general formula:

Ar(COOH)ₙ

wherein Ar represents aryl or substituted aryl and n is an integer greater than or equal to 2.

In some embodiments Ar is selected from the group consisting of an optionally substituted single aromatic ring and optionally substituted multiple aromatic rings which are fused together, directly linked, or indirectly linked through one or more linking groups.

In some embodiments Ar is an optionally substituted polyaromatic hydrocarbon or an optionally substituted polyheterocyclic.

The carboxylate substituents may be on the same or different rings of Ar.

In any one of the herein disclosed embodiments the polycarboxylic acid chloride has the general formula:

Ar(COCl)ₙ

wherein Ar represents aryl or substituted aryl and n is an integer greater than or equal to 2.

In some embodiments Ar is selected from the group consisting of an optionally substituted single aromatic ring and optionally substituted multiple aromatic rings which are fused together, directly linked, or indirectly linked through one or more linking groups.

In some embodiments Ar is an optionally substituted polyaromatic hydrocarbon or an optionally substituted polyheterocyclic.

The acid chloride substituents may be on the same or different rings of Ar.

In any one of the herein disclosed embodiments the mixed polycarboxylic acids/acid chlorides have the general formula:

Ar(COOH)ₘ(COCl)ₙ

wherein Ar represents aryl or substituted aryl and both n and m are integers greater than or equal to 1.

In some embodiments Ar is selected from the group consisting of an optionally substituted single aromatic ring and optionally substituted multiple aromatic rings which are fused together, directly linked, or indirectly linked through one or more linking groups.

In some embodiments Ar is an optionally substituted polyaromatic hydrocarbon or an optionally substituted polyheterocyclic.

The carboxylate and acid chloride substituents may be on the same or different rings of Ar.

In any one of the herein disclosed embodiments the polycarboxylic acid anhydride has the general formula:

Ar(COOCO)ₘ

wherein Ar represents aryl or substituted aryl and m is an integer greater than or equal to 2.

In some embodiments Ar is selected from the group consisting of an optionally substituted single aromatic ring and optionally substituted multiple aromatic rings which are fused together, directly linked, or indirectly linked through one or more linking groups.

In some embodiments Ar is an optionally substituted polyaromatic hydrocarbon or an optionally substituted polyheterocyclic.

The acid anhydride substituents may be on the same or different rings of Ar.

In any one of the herein disclosed embodiments the polycarboxylic acid chloride anhydride has the general formula:

Ar(COOCO)ₘ(COCl)ₙ

wherein Ar represents aryl or substituted aryl and both n and m are integers greater than or equal to 1.

In some embodiments Ar is selected from the group consisting of an optionally substituted single aromatic ring and optionally substituted multiple aromatic rings which are fused together, directly linked, or indirectly linked through one or more linking groups.

In some embodiments Ar is an optionally substituted polyaromatic hydrocarbon or an optionally substituted polyheterocyclic.

The acid anhydride substituents and acid chloride substituents may be, independently, on the same or different rings of Ar.

In any one of the herein disclosed embodiments the polyamine has the general formula:

Ar(NH₂)ₚ

wherein Ar represents aryl or substituted aryl and p is an integer greater than or equal to 2.

In some embodiments Ar is selected from the group consisting of an optionally substituted single aromatic ring and optionally substituted multiple aromatic rings which are fused together, directly linked, or indirectly linked through one or more linking groups.

In some embodiments Ar is an optionally substituted polyaromatic hydrocarbon or an optionally substituted polyheterocyclic.

The amine substituents may be on the same or different rings of Ar.

In some embodiments the polyamines are selected from the group consisting of p-phenylenediamine, m-phenylenediamine, o-phenylenediamine, 2,4,6-trimethyl-m-phenylenediamine, naphthalene-1,4-diamine, naphthalene-2,3-diamine, naphthalene-1,2-diamine, naphthalene-1,5-diamine, naphthalene-1,8-diamine, phenanthrene-9,10-diamine, 4-methylbenzene-1,3-diamine, 2-methylbenzene-1,3-diamine, 3-methylbenzene-1,2-diamine, 4-methylbenzene-1,2-diamine, 4,5-dimethylbenzene-1,2-diamine, 4,5-dimethylbenzene-1,3-diamine, 3,4-dimethylbenzene-1,2-diamine, 2,3-dimethylbenzene-1,4-diamine, 2,5-dimethylbenzene-1,3-diamine, 2,5-dimethylbenzene-1,4-diamine, 6-dimethylbenzene-1,2-diamine, 4,6-dimethylbenzene-1,3-diamine, 2,4-dimethylbenzene-1,3-diamine, 2,3,5,6-tetramethyl-p-phenylenediamine, 4,4′-oxydianiline, 4,4′-(hexafluoroisopropylidene)dianiline, 5,5′-(hexafluoroisopropylidene)o-toluidine, 4,4′-(hexafluoroisopropydene)bis(p-phenyleneoxy)dianiline, 4,4′-(1,4-phenylenediisopropylidene)bisaniline, 4,4′-(1,3-phenylenedioxy)dianiline, 4,4′-(1,1′-biphenyl-4,4′-diyldioxy)dianiline, and 4,4′-diaminooctafluorobiphenyl.

In some embodiments the polycarboxylic acids are selected from the group consisting of phthalic acid, isophthalic acid, terephthalic acid, naphthalene-1,4-dicarboxylic acid, naphthalene-2,3-dicarboxylic acid, naphthalene-2,6-dicarboxylic acid, [1,1-biphenyl]-4,4′-dicarboxylic acid, [1,1-biphenyl]-2,2′-dicarboxylic acid, 4,4′-oxydibenzoic acid, 4,4′-sulfonyldibenzoic acid, 4,4′-(hexafluoroisopropylidene)bis(benzoic acid), 4,4′sulfonyldibenzoic acid, mellitic acid, 1,1-binaphthyl-8,8-dicarboxylic acid, and 1,2,4,5-benzenetetracarboxylic acid.

In some embodiments the two or more polycarboxylic acid anhydrides are selected from the group consisting of pyromellitic dianhydride (benzene-1,2,4,5-tetracarboxylic dianhydride), 3,3′,4,4′-biphenyltetracarboxylic dianhydride, 4,4′-oxydiphthalic anhydride, 4,4′-(hexafluoroisopropylidene)diphthalic anhydride, 4,4′(4,4′-isopropylidenediphenoxy)bis(phthalic anhydride) 1,4,5,8-naphthalene tetracarboxylic dianhydride, perylene-3,4,9,10-tetracarboxylic dianhydride, 1,4,5,8-naphthalene tetracarboxylic dianhydride, bicycle(2,2,2)oct-7-ene-2,3,5,6-tetracarboxylic dianhydride, 4,4′-(4,4′-isopropylidenediphenoxy)bis (phthalic anhydride) and benzophenone-3,3′,4,4′-biphenyltetracarboxylic dianhydride.

In some embodiments the acid chlorides are selected from the group consisting of isophthaloyl chloride, phthaloyl chloride, terephthaloyl chloride, 1,3,5-benzene tricarbonyl trichloride, naphthalene-1,4-dicarbonyl dichloride, naphthalene-2,6-dicarbonyl dichloride, naphthalene-2,3-dicarbonyl dichloride, naphthalene-1,8-dicarbonyl dichloride, [1,1′-biphenyl]-2,2′-dicarbonyl dichloride, and [1,1′-biphenyl]-4,4′-dicarbonyl dichloride.

In some embodiments the polycarboxylic acid chloride anhydrides are selected from the group consisting of trimellitic acid chloride, 4-(1,3-dioxo-1,3-dihydroisobenzofuran yl)benzoyl chloride, 4′-(chlorocarbonyl)[1,1′-biphenyl]-4-carboxylic acid, 4′-(chlorocarbonyl)-[1,1′-biphenyl]-4-carboxylic acid, 1,3-dioxo-1,3-dihydronaphtho[1,2-c]furan-7-carbonyl chloride, and 6-(chlorocarbonyl)naphthalene-1,2-dicarboxylic acid.

In some preferred embodiments the two or more polyamines are structural isomers of naphthalenediamine or biphenyldiamine.

In other preferred embodiments the two or more polycarboxylic acids are structural isomers of phenylenedicarboxylic acid, naphthalenedicarboxylic acid, or biphenyldicarboxylic acid.

The polymers formed by the methods disclosed herein may be thermoplastic. Alternatively, the polymers formed by the methods disclosed herein may be thermoset.

In another aspect of the present disclosure there is provided a mixed polyamide obtained or obtainable by any one of the methods as disclosed herein

In another aspect of the present disclosure there is provided a mixed polyimide obtained or obtainable by any one of the methods as disclosed herein.

In another aspect of the present disclosure there is provided a mixed polyamideimide obtained or obtainable by any one of the methods as disclosed herein.

In another aspect of the present disclosure there is provided a mixed polyamide wherein said mixed polyamide is derived from one or more polycarboxylic acids and one or more polyamines;

wherein the polycarboxylic acids are selected from the group consisting of phthalic acid, isophthalic acid, terephthalic acid, naphthalene-1,4-dicarboxylic acid, naphthalene-2,3-dicarboxylic acid, naphthalene-2,6-dicarboxylic acid, [1,1-biphenyl]-4,4′-dicarboxylic acid, [1,1-biphenyl]-2,2′-dicarboxylic acid, 4,4′-oxydibenzoic acid, 4,4′-sulfonyldibenzoic acid, 4,4′-(hexafluoroisopropylidene)bis(benzoic acid), 4,4′ sulfonyldibenzoic acid, mellitic acid, 1,1-binaphthyl-8,8-dicarboxylic acid, and 1,2,4,5-benzenetetracarboxylic acid;
wherein the polyamines are selected from the group consisting of p-phenylenediamine, m-phenylenediamine, o-phenylenediamine, 2,4,6-trimethyl-m-phenylenediamine, naphthalene-1,4-diamine, naphthalene-2,3-diamine, naphthalene-1,2-diamine, naphthalene-1,5-diamine, naphthalene-1,8-diamine, phenanthrene-9,10-diamine, 4-methylbenzene-1,3-diamine, 2-methylbenzene-1,3-diamine, 3-methylbenzene-1,2-diamine, 4-methylbenzene-1,2-diamine, 4,5-dimethylbenzene-1,2-diamine, 4,5-dimethylbenzene-1,3-diamine, 3,4-dimethylbenzene-1,2-diamine, 2,3-dimethylbenzene-1,4-diamine, 2,5-dimethylbenzene-1,3-diamine, 2,5-dimethylbenzene-1,4-diamine, 6-dimethylbenzene-1,2-diamine, 4,6-dimethylbenzene-1,3-diamine, 2,4-dimethylbenzene-1,3-diamine, 2,3,5,6-tetramethyl-p-phenylenediamine, 4,4′-oxydianiline, 4,4′-(hexafluoroisopropylidene)dianiline, 5,5′-(hexafluoroisopropylidene)o-toluidine, 4,4′-(hexafluoroisopropylidene)bis(p-phenyleneoxy)dianiline, 4,4′-(1,4-phenylenediisopropylidene)bisaniline, 4,4′-(1,3-phenylenedioxy)dianiline, 4,4′-(1,1′-biphenyl-4,4′-diyldioxy)dianiline, and 4,4′-diaminooctafluorobiphenyl;
with the proviso that the polyamide is derived from at least two or more of the polycarboxylic acids or at least two or more of the polyamines.

In another aspect of the present disclosure there is provided a mixed polyamide wherein said mixed polyamide is derived from one or more polycarboxylic acid chlorides and one or more polyamines;

wherein the polycarboxylic acid chlorides are selected from the group consisting of isophthaloyl chloride, phthaloyl chloride, terephthaloyl chloride, 1,3,5-benzene tricarbonyl trichloride, naphthalene-1,4-dicarbonyl dichloride, naphthalene-2,6-dicarbonyl dichloride, naphthalene-2,3-dicarbonyl dichloride, naphthalene-1,8-dicarbonyl dichloride, [1,1′-biphenyl]-2,2′-dicarbonyl dichloride, and [1,1′-biphenyl]-4,4′-dicarbonyl dichloride;
wherein the polyamines are selected from the group consisting of p-phenylenediamine, m-phenylenediamine, o-phenylenediamine, 2,4,6-trimethyl-m-phenylenediamine, naphthalene-1,4-diamine, naphthalene-2,3-diamine, naphthalene-1,2-diamine, naphthalene-1,5-diamine, naphthalene-1,8-diamine, phenanthrene-9,10-diamine, 4-methylbenzene-1,3-diamine, 2-methylbenzene-1,3-diamine, 3-methylbenzene-1,2-diamine, 4-methylbenzene-1,2-diamine, 4,5-dimethylbenzene-1,2-diamine, 4,5-dimethylbenzene-1,3-diamine, 3,4-dimethylbenzene-1,2-diamine, 2,3-dimethylbenzene-1,4-diamine, 2,5-dimethylbenzene-1,3-diamine, 2,5-dimethylbenzene-1,4-diamine, 6-dimethylbenzene-1,2-diamine, 4,6-dimethylbenzene-1,3-diamine, 2,4-dimethylbenzene-1,3-diamine, 2,3,5,6-tetramethyl-p-phenylenediamine, 4,4′-oxydianiline, 4,4′-(hexafluoroisopropylidene)dianiline, 5,5′-(hexafluoroisopropylidene)o-toluidine, 4,4′-(hexafluoroisopropylidene)bis(p-phenyleneoxy)dianiline, 4,4′-(1,4-phenylenediisopropylidene)bisaniline, 4,4′-(1,3-phenylenedioxy)dianiline, 4,4′-(1,1′-biphenyl-4,4′-diyldioxy)dianiline, and 4,4′-diaminooctafluorobiphenyl;
with the proviso that the polyamide is derived from at least two or more of the polycarboxylic acid chlorides or at least two or more of the polyamines.

In another aspect of the present disclosure there is provided a mixed polyimide wherein said mixed polyimide is derived from one or more polycarboxylic acid anhydrides and one or more polyamines;

wherein the polycarboxylic acid anhydrides are selected from the group consisting of pyromellitic dianhydride (benzene-1,2,4,5-tetracarboxylic dianhydride), 3,3′,4,4′-biphenyltetracarboxylic dianhydride, 4,4′-oxydiphthalic anhydride, 4,4′-(hexafluoroisopropydene)diphthalic anhydride, 4,4′(4,4′-isopropylidenediphenoxy)bis(phthalic anhydride) 1,4,5,8-naphthalene tetracarboxylic dianhydride, perylene-3,4,9,10-tetracarboxylic dianhydride, 1,4,5,8-naphthalene tetracarboxylic dianhydride, bicycle(2,2,2)oct-7-ene-2,3,5,6-tetracarboxylic dianhydride, 4,4′-(4,4′-isopropylidenediphenoxy)bis (phthalic anhydride) and benzophenone-3,3′,4,4′-biphenyltetracarboxylic dianhydride;
wherein the polyamines are selected from the group consisting of p-phenylenediamine, m-phenylenediamine, o-phenylenediamine, 2,4,6-trimethyl-m-phenylenediamine, naphthalene-1,4-diamine, naphthalene-2,3-diamine, naphthalene-1,2-diamine, naphthalene-1,5-diamine, naphthalene-1,8-diamine, phenanthrene-9,10-diamine, 4-methylbenzene-1,3-diamine, 2-methylbenzene-1,3-diamine, 3-methylbenzene-1,2-diamine, 4-methylbenzene-1,2-diamine, 4,5-dimethylbenzene-1,2-diamine, 4,5-dimethylbenzene-1,3-diamine, 3,4-dimethylbenzene-1,2-diamine, 2,3-dimethylbenzene-1,4-diamine, 2,5-dimethylbenzene-1,3-diamine, 2,5-dimethylbenzene-1,4-diamine, 6-dimethylbenzene-1,2-diamine, 4,6-dimethylbenzene-1,3-diamine, 2,4-dimethylbenzene-1,3-diamine, 2,3,5,6-tetramethyl-p-phenylenediamine, 4,4′-oxydianiline, 4,4′-(hexafluoroisopropylidene)dianiline, 5,5′-(hexafluoroisopropylidene)o-toluidine, 4,4′-(hexafluoroisopropylidene)bis(p-phenyleneoxy)dianiline, 4,4′-(1,4-phenylenediisopropylidene)bisaniline, 4,4′-(1,3-phenylenedioxy)dianiline, 4,4′-(1,1′-biphenyl-4,4′-diyldioxy)dianiline, and 4,4′-diaminooctafluorobiphenyl;
with the proviso that the polyamide is derived from at least two or more of the polycarboxylic acid anhydrides or at least two or more of the polyamines.

In another aspect of the present disclosure there is provided an article of manufacture comprising any one or more of the polymers disclosed herein.

The article may be, for example, automotive engine parts, electric and electronic components, films, fibers, components in infrastructure applications, both load or non-load bearing, such as, for example, beams, columns and panels.

In another aspect of the present disclosure there is provided a composite comprising any one or more of the polymers as disclosed herein and one or more other materials. The other material may be one or more other polymers.

Further features and advantages of the present disclosure will be understood by reference to the following drawings and detailed description.

### BRIEF DESCRIPTION OF THE DRAWINGS

FIG. 1 illustrates the thermogravimetric analysis (TGA) of a polyimide prepared under hydrothermal conditions of Example 1.

FIG. 2 illustrates the solid state 13C NMR of a polyimide prepared under hydrothermal conditions of Example 1.

FIG. 3 illustrates the thermogravimetric analysis (TGA) of a polyimide prepared under hydrothermal conditions of Example 3.

FIG. 4 illustrates the thermogravimetric analysis (TGA) of a mixed polyimide prepared under hydrothermal conditions of Example 4.

### DETAILED DESCRIPTION OF THE INVENTION

The following is a detailed description of the disclosure provided to aid those skilled in the art in practicing the present disclosure. Those of ordinary skill in the art may make modifications and variations in the embodiments described herein without departing from the spirit or scope of the present disclosure.

Although any compositions, methods and materials similar or equivalent to those described herein can also be used in the practice or testing of the present disclosure, the preferred compositions, methods and materials are now described.

It must also be noted that, as used in the specification and the appended claims, the singular forms ‘a’, ‘an’ and ‘the’ include plural referents unless otherwise specified. Thus, for example, reference to ‘polyamine’ may include more than one polyamine, and the like.

Throughout this specification, use of the terms ‘comprises’ or ‘comprising’ or grammatical variations thereon shall be taken to specify the presence of stated features, integers, steps or components but does not preclude the presence or addition of one or more other features, integers, steps, components or groups thereof not specifically mentioned.

Unless specifically stated or obvious from context, as used herein, the term ‘about’ is understood as within a range of normal tolerance in the art, for example within two standard deviations of the mean. ‘About’ can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term ‘about’.

Any processes provided herein can be combined with one or more of any of the other processes provided herein.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14th Edition, by R. J. Lewis, John Wiley & Sons, New York, N.Y., 2001.

The term “aromatic” as used herein refers to the ring moieties which satisfy the Huckel 4n+2 rule for aromaticity, and includes both aryl (i.e., carbocyclic) and heteroaryl (also called heteroaromatic) structures, including aryl, aralkyl, alkaryl, heteroaryl, heteroaralkyl, or alk-heteroaryl moieties, or oligomeric or polymeric analogs thereof.

The term “aryl” as used herein, and unless otherwise specified, refers to an aromatic substituent or structure containing a single aromatic ring or multiple aromatic rings that are fused together, directly linked, or indirectly linked (such that the different aromatic rings are bound to a common group such as a methylene or ethylene moiety). Unless otherwise modified, the term “aryl” refers to carbocyclic structures. Preferred aryl groups contain 5 to 24 carbon atoms, and particularly preferred aryl groups contain 5 to 14 carbon atoms. Exemplary aryl groups contain one aromatic ring or two fused or linked aromatic rings, e.g., phenyl, naphthyl, biphenyl, diphenylether, benzophenone, and the like. “Substituted aryl” refers to an aryl moiety substituted with one or more substituent groups, and the terms “heteroatom-containing aryl” and “heteroaryl” refer to aryl substituents in which at least one carbon atom is replaced with a heteroatom.

As used herein, a ‘polyaromatic hydrocarbon’ refers to a hydrocarbon substituent or structure having at least two rings, at least one of which is aromatic. Polyaromatic hydrocarbons fall within the class of aryl compounds and may comprise one or more aromatic rings with 4- or 5- or 6- or 7-, or 8 or more-membered carbon rings. They may be either alternant aromatic hydrocarbons (benzenoids), or non-alternant hydrocarbons, which may be either non-alternant conjugated or non-alternant non-conjugated hydrocarbons. Examples of polyaromatic hydrocarbons include, but are not limited to, acenaphthene, acenaphthylene, anthanthrene, anthracene, azulene, benzo[a]anthracene, benzo[a]fluorine, benzo[c]phenanthrene, benzopyrene, benzo[a]pyrene, benzo[e]pyrene, benzo[b]fluoranthene, benzo[j]fluoranthene, benzo[k]fluoranthene, benzo[ghi]perylene, chrysene, corannulene, coronene, dicoronylene, diindenoperylene, fluorene, fluoranthene, fullerene, helicene, heptacene, hexacene, indene, kekulene, naphthalene, ovalene, pentacene, perylene, phenalene, phenanthrene, dihydrophenanthrene, picene, pyrene, tetracene, triphenylene, and their isomers or derivatives or combinations or condensed forms.

The polyaromatic hydrocarbons may also comprise structures which contain the above disclosed polyaromatic hydrocarbons as fragments within larger structures.

As used herein, ‘polyheterocyclic’ refers to a heterocycle having at least two rings, at least one of which is aromatic. Polyheterocyclics can also be referred to as heteroaromatics. As used herein, a heterocycle is cyclic aromatic that includes at least one heteroatom in an aromatic ring. Typical heteroatoms include oxygen, nitrogen, and sulfur. Examples of polyheterocyclics include, but are not limited to, acridine, benzimidazole, 2H-1-benzothine, benzthiazole, benzo[b]furan, benzo[b]thiophene, benzo[c]thiophene, carbazole, cinnoline, dibenzothiophene, iminodibenzyl, 1H-indazole, indole, indolizine, isoindole, isoquinoline, 1,5-naphthyridine, 1,8-naphthyridine, phenanthridine phenanthroline, phenazine, phenoxazine, phenothiazine, phthalazine, quinazoline, quinoline, 4H-quinolizine, thianthrene, and xanthene and their isomers, derivatives or combinations.

The polyheterocyclic may also comprise structures which contain the above disclosed polyheterocyclics as fragments within larger structures.

The term “mixed polyamide” as used herein refers to a polyamide that is derived from at least two different polyamines and/or at least two different polycarboxylic acids.

The term “mixed polyimide” as used herein refers to a polyimide that is derived from at least two different polyamines and/or at least two different polycarboxylic acid anhydrides.

The term “mixed polyamideimide” as used herein refers to a polyamide imide that is derived from at least two different polyamines and/or at least two different polycarboxylic acid chloride anhydrides.

As used herein, the term “at least two different” when applied to molecules refers to at least two different molecular structures or at least two different structural isomers.

As used herein, the term “mixed polycarboxylic acid/acid chloride” refers to a molecule comprising one or more carboxylate moieties and one or more acid chloride moieties.

As used herein, the term “polycarboxylic acid anhydride” refers to a molecule comprising two or more carboxylic acid anhydride moieties.

As used herein, the term “tetracarboxylic acid dianhydride” refers to a molecule comprising two carboxylic acid anhydride moieties, for example 3,3′,4,4′-biphenyltetracarboxylic dianhydride.

As used herein, the term “polycarboxylic acid chloride anhydride” refers to a molecule comprising one or more carboxylic acid anhydride moieties and one or more acid chloride moieties.

For example, Table 1 illustrates a number of polycarboxylic acids useful in the synthesis of polymers according to the present disclosure.

TABLE 1

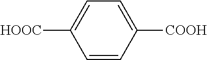 [SMILES: O=C(O)c1ccc(C(=O)O)cc1]

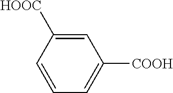 [SMILES: O=C(O)c1cccc(C(=O)O)c1]

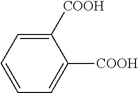 [SMILES: O=C(O)c1ccccc1C(=O)O]

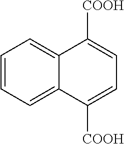 [SMILES: O=C(O)c1ccc(C(=O)O)c2ccccc12]

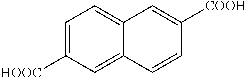 [SMILES: O=C(O)c1ccc2cc(C(=O)O)ccc2c1]

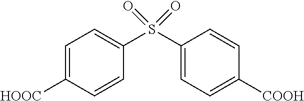 [SMILES: O=C(O)c1ccc(S(=O)(=O)c2ccc(C(=O)O)cc2)cc1]

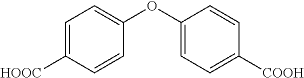 [SMILES: O=C(O)c1ccc(Oc2ccc(C(=O)O)cc2)cc1]

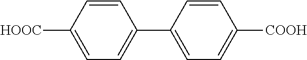 [SMILES: O=C(O)c1ccc(-c2ccc(C(=O)O)cc2)cc1]

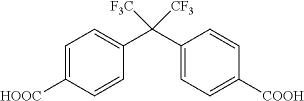 [SMILES: O=C(O)c1ccc(C(c2ccc(C(=O)O)cc2)(C(F)(F)F)C(F)(F)F)cc1]

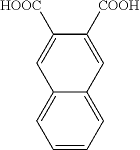 [SMILES: O=C(O)c1cc2ccccc2cc1C(=O)O]

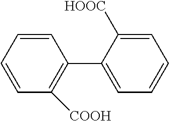 [SMILES: O=C(O)c1ccccc1-c1ccccc1C(=O)O]

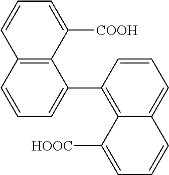 [SMILES: O=C(O)c1cccc2cccc(-c3cccc4cccc(C(=O)O)c34)c12]

Table 2 illustrates a number of polycarboxylic acid anhydrides useful in the synthesis of polymers according to the present disclosure.

TABLE 2

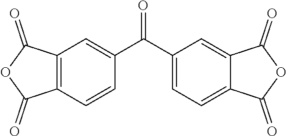 [SMILES: O=C(c1ccc2c(c1)C(=O)OC2=O)c1ccc2c(c1)C(=O)OC2=O]

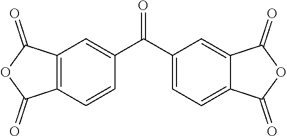 [SMILES: O=C(c1ccc2c(c1)C(=O)OC2=O)c1ccc2c(c1)C(=O)OC2=O]

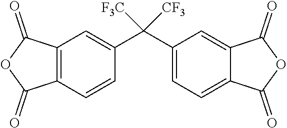 [SMILES: O=C1OC(=O)c2cc(C(c3ccc4c(c3)C(=O)OC4=O)(C(F)(F)F)C(F)(F)F)ccc21]

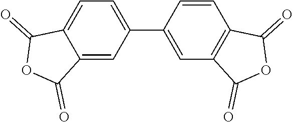 [SMILES: O=C1OC(=O)c2cc(-c3ccc4c(c3)C(=O)OC4=O)ccc21]

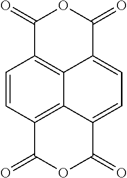 [SMILES: O=C1OC(=O)c2ccc3c4c(ccc1c24)C(=O)OC3=O]

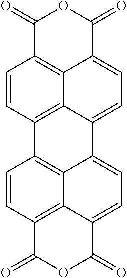 [SMILES: O=C1OC(=O)c2ccc3c4ccc5c6c(ccc(c7ccc1c2c73)c64)C(=O)OC5=O]

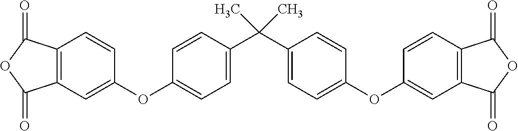 [SMILES: CC(C)(c1ccc(Oc2ccc3c(c2)C(=O)OC3=O)cc1)c1ccc(Oc2ccc3c(c2)C(=O)OC3=O)cc1]

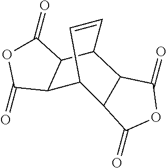 [SMILES: O=C1OC(=O)C2C3C=CC(C12)C1C(=O)OC(=O)C31]

Table 3 illustrates a number of polyamines useful in the synthesis of any of the herein disclosed polymers.

TABLE 3

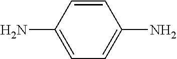

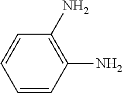

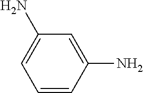

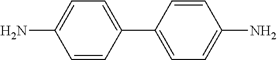 [SMILES: Nc1ccc(-c2ccc(N)cc2)cc1]

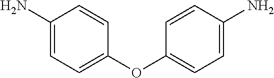 [SMILES: Nc1ccc(Oc2ccc(N)cc2)cc1]

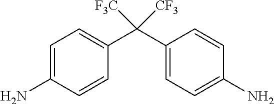 [SMILES: Nc1ccc(C(c2ccc(N)cc2)(C(F)(F)F)C(F)(F)F)cc1]

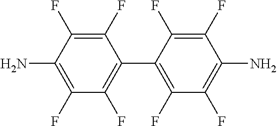 [SMILES: Nc1c(F)c(F)c(-c2c(F)c(F)c(N)c(F)c2F)c(F)c1F]

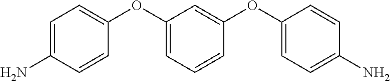 [SMILES: Nc1ccc(Oc2cccc(Oc3ccc(N)cc3)c2)cc1]

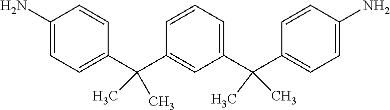 [SMILES: CC(C)(c1ccc(N)cc1)c1cccc(C(C)(C)c2ccc(N)cc2)c1]

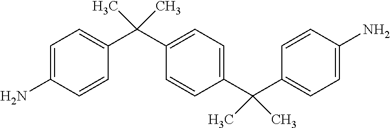 [SMILES: CC(C)(c1ccc(N)cc1)c1ccc(C(C)(C)c2ccc(N)cc2)cc1]

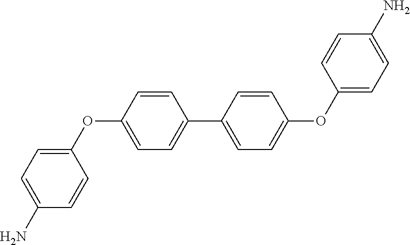 [SMILES: Nc1ccc(Oc2ccc(-c3ccc(Oc4ccc(N)cc4)cc3)cc2)cc1]

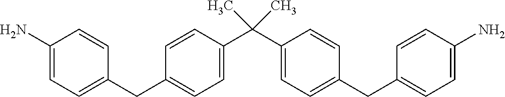 [SMILES: CC(C)(c1ccc(Cc2ccc(N)cc2)cc1)c1ccc(Cc2ccc(N)cc2)cc1]

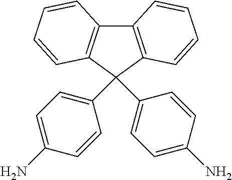 [SMILES: Nc1ccc(C2(c3ccc(N)cc3)c3ccccc3-c3ccccc32)cc1]

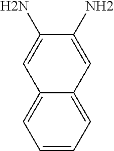 [SMILES: Nc1cc2ccccc2cc1N]

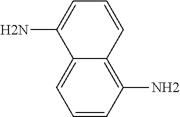 [SMILES: Nc1cccc2c(N)cccc12]

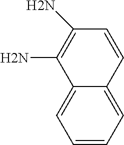 [SMILES: Nc1ccc2ccccc2c1N]

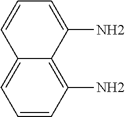 [SMILES: Nc1cccc2cccc(N)c12]

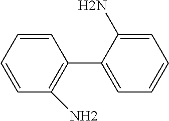 [SMILES: Nc1ccccc1-c1ccccc1N]

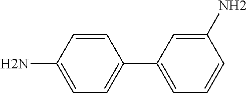 [SMILES: Nc1ccc(-c2cccc(N)c2)cc1]

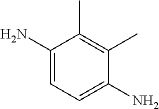

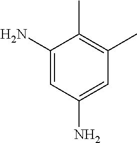

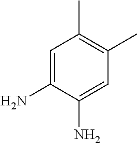

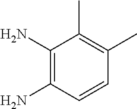

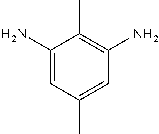

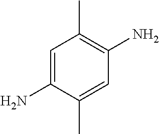

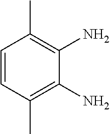

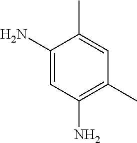

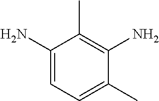

The following schemes illustrate methods according to exemplary embodiments of the present disclosure.

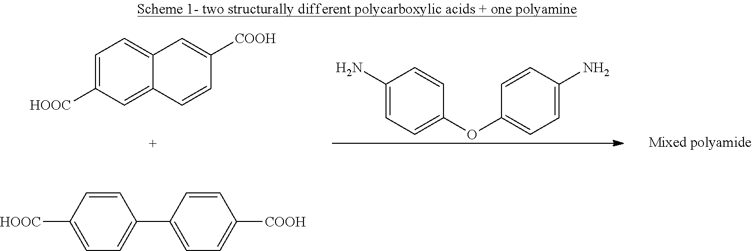 [SMILES: O=C(O)c1ccc2cc(C(=O)O)ccc2c1 ; Nc1ccc(Oc2ccc(N)cc2)cc1 ; O=C(O)c1ccc(-c2ccc(C(=O)O)cc2)cc1]

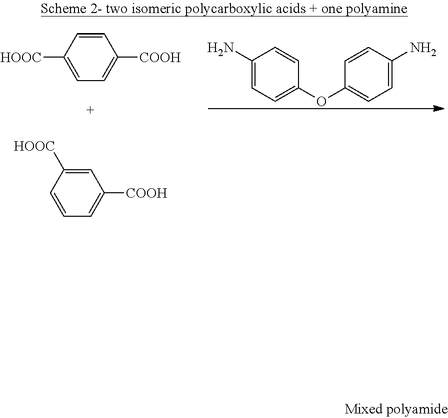 [SMILES: O=C(O)c1ccc(C(=O)O)cc1 ; Nc1ccc(Oc2ccc(N)cc2)cc1 ; O=C(O)c1cccc(C(=O)O)c1]

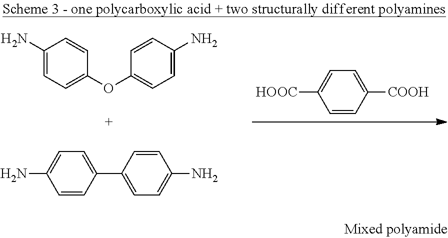 [SMILES: Nc1ccc(Oc2ccc(N)cc2)cc1 ; O=C(O)c1ccc(C(=O)O)cc1 ; Nc1ccc(-c2ccc(N)cc2)cc1]

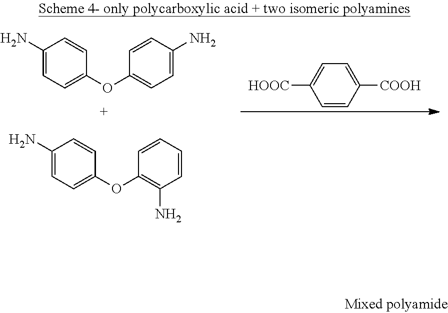 [SMILES: Nc1ccc(Oc2ccc(N)cc2)cc1 ; O=C(O)c1ccc(C(=O)O)cc1 ; Nc1ccc(Oc2ccccc2N)cc1]

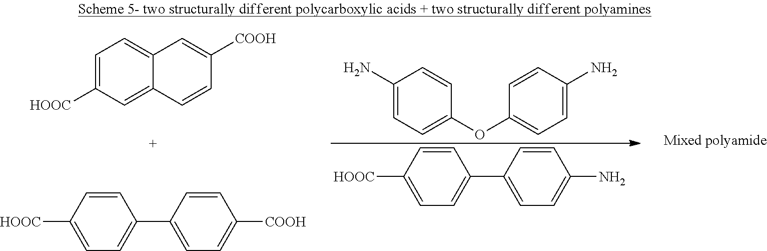

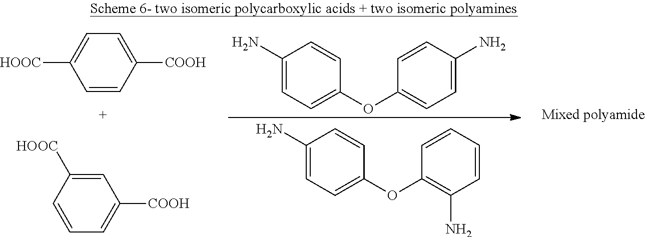

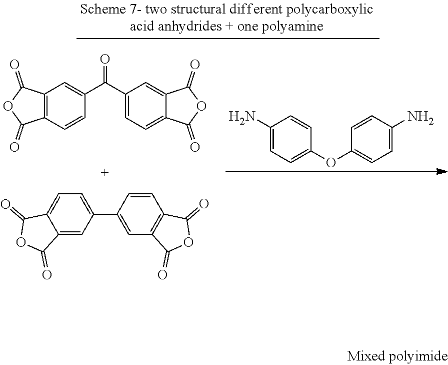 [SMILES: O=C(c1ccc2c(c1)C(=O)OC2=O)c1ccc2c(c1)C(=O)OC2=O ; Nc1ccc(Oc2ccc(N)cc2)cc1 ; O=C1OC(=O)c2cc(-c3ccc4c(c3)C(=O)OC4=O)ccc21]

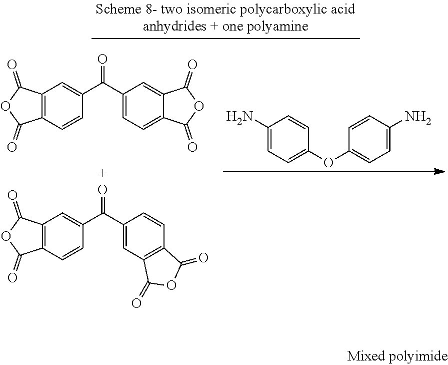 [SMILES: O=C(c1ccc2c(c1)C(=O)OC2=O)c1ccc2c(c1)C(=O)OC2=O ; Nc1ccc(Oc2ccc(N)cc2)cc1 ; O=C(c1ccc2c(c1)C(=O)OC2=O)c1ccc2c(c1)C(=O)OC2=O]

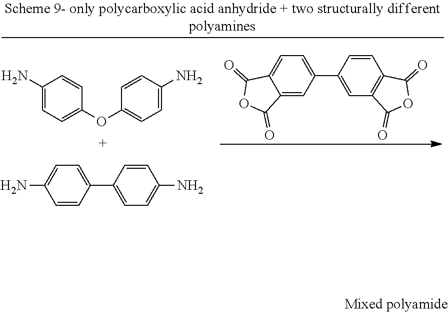 [SMILES: Nc1ccc(Oc2ccc(N)cc2)cc1 ; O=C1OC(=O)c2cc(-c3ccc4c(c3)C(=O)OC4=O)ccc21 ; Nc1ccc(-c2ccc(N)cc2)cc1]

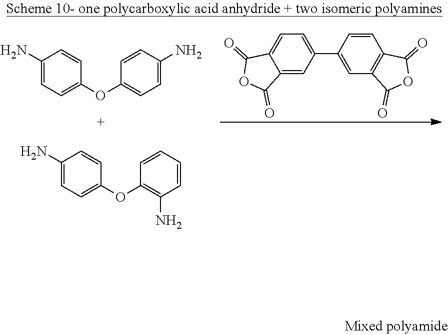 [SMILES: Nc1ccc(Oc2ccc(N)cc2)cc1 ; O=C1OC(=O)c2cc(-c3ccc4c(c3)C(=O)OC4=O)ccc21 ; Nc1ccc(Oc2ccccc2N)cc1]

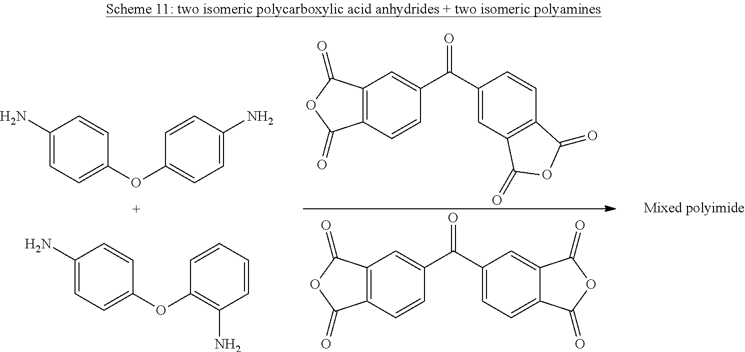 [SMILES: Nc1ccc(Oc2ccc(N)cc2)cc1 ; O=C(c1ccc2c(c1)C(=O)OC2=O)c1ccc2c(c1)C(=O)OC2=O ; Nc1ccc(Oc2ccccc2N)cc1 ; O=C(c1ccc2c(c1)C(=O)OC2=O)c1ccc2c(c1)C(=O)OC2=O]

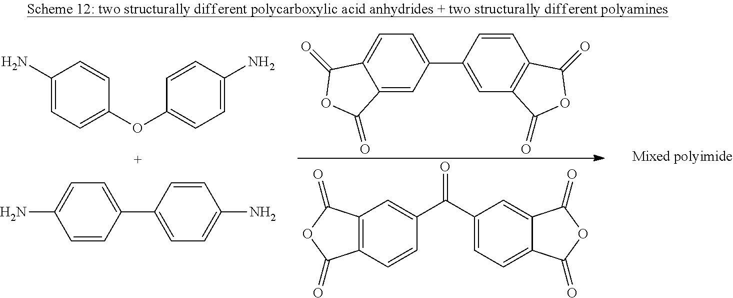 [SMILES: Nc1ccc(Oc2ccc(N)cc2)cc1 ; O=C1OC(=O)c2cc(-c3ccc4c(c3)C(=O)OC4=O)ccc21 ; Nc1ccc(-c2ccc(N)cc2)cc1 ; O=C(c1ccc2c(c1)C(=O)OC2=O)c1ccc2c(c1)C(=O)OC2=O]

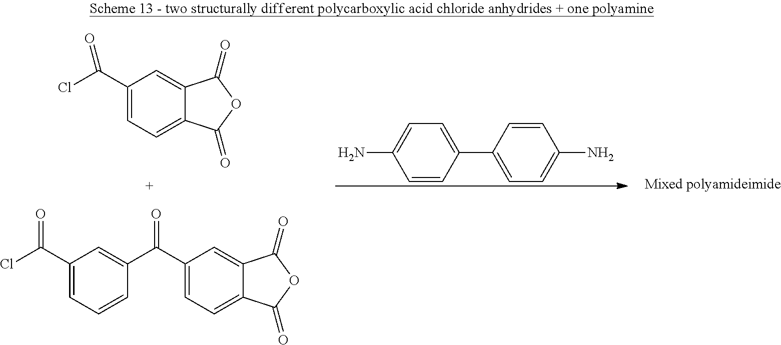 [SMILES: O=C(Cl)c1ccc2c(c1)C(=O)OC2=O ; Nc1ccc(-c2ccc(N)cc2)cc1 ; O=C(Cl)c1cccc(C(=O)c2ccc3c(c2)C(=O)OC3=O)c1]

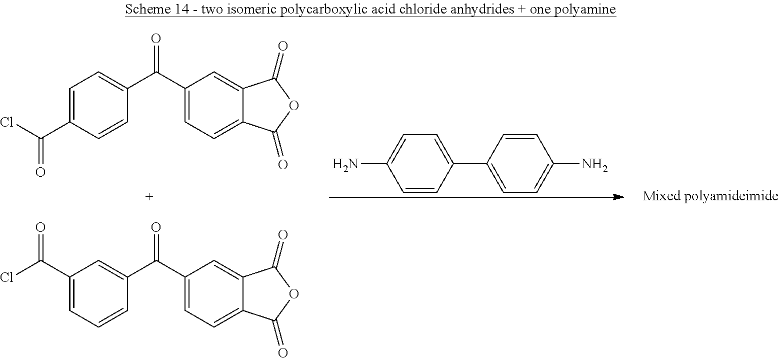 [SMILES: O=C(Cl)c1ccc(C(=O)c2ccc3c(c2)C(=O)OC3=O)cc1 ; Nc1ccc(-c2ccc(N)cc2)cc1 ; O=C(Cl)c1cccc(C(=O)c2ccc3c(c2)C(=O)OC3=O)c1]

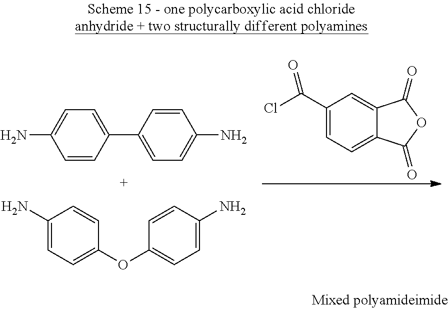 [SMILES: Nc1ccc(-c2ccc(N)cc2)cc1 ; O=C(Cl)c1ccc2c(c1)C(=O)OC2=O ; Nc1ccc(Oc2ccc(N)cc2)cc1]

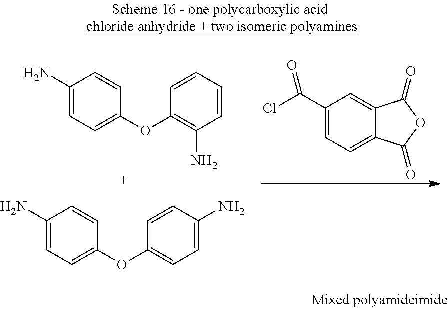 [SMILES: Nc1ccc(Oc2ccccc2N)cc1 ; O=C(Cl)c1ccc2c(c1)C(=O)OC2=O ; Nc1ccc(Oc2ccc(N)cc2)cc1]

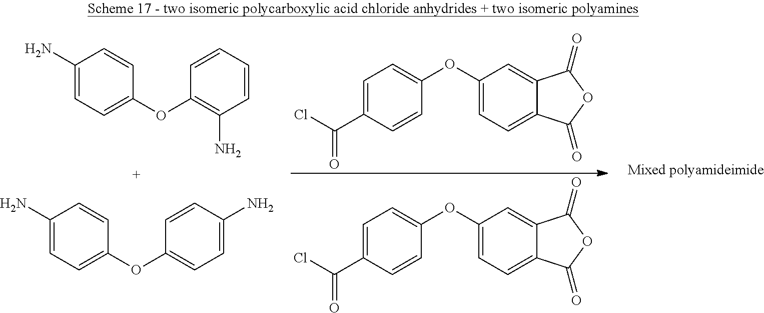

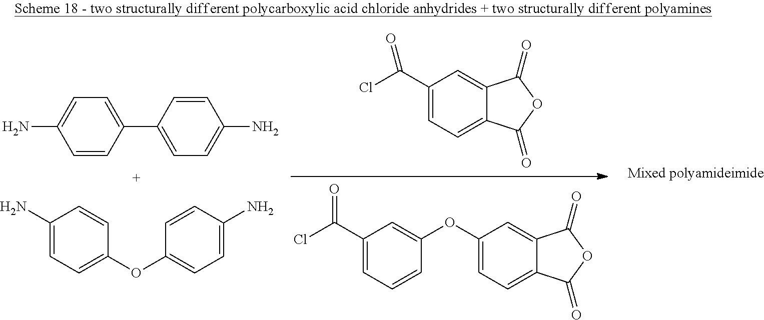 [SMILES: Nc1ccc(-c2ccc(N)cc2)cc1 ; O=C(Cl)c1ccc2c(c1)C(=O)OC2=O ; Nc1ccc(Oc2ccc(N)cc2)cc1 ; O=C(Cl)c1cccc(Oc2ccc3c(c2)C(=O)OC3=O)c1]

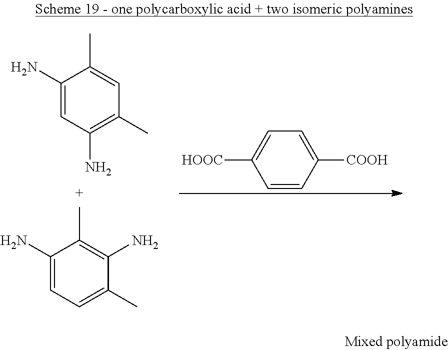

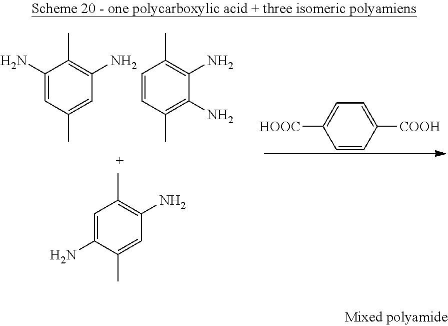

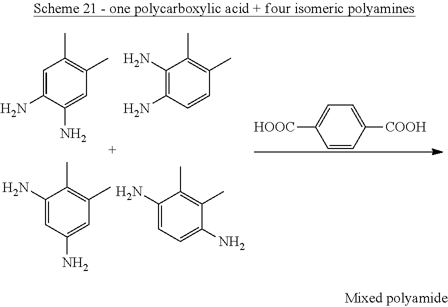

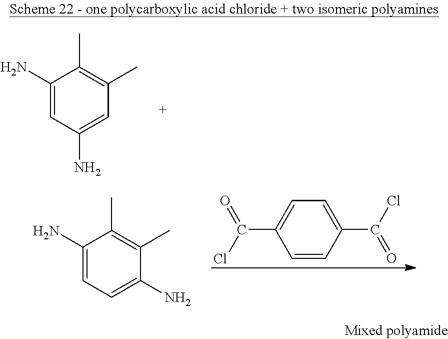

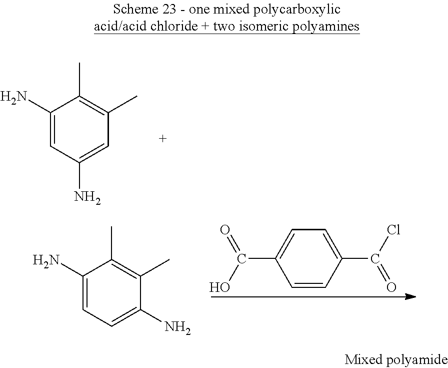

Although the above exemplary schemes illustrate the use of dicarboxylic acids, dianhydrides and diamines, the present disclosure also contemplates higher substitutions, for example tetracarboxylic acids or triamines. The use of such molecules in the methods of the present disclosure may lead to crosslinked polymers.

The hydrothermal temperature region is between the normal boiling point of water and the supercritical temperature. Preferably the herein disclosed hydrothermal polymerizations are conducted at a temperature between 150° C. and 250° C.

Typically, the reaction time for polymerization is between 5 minutes and 72 hrs, preferably between 30 mins and 48 hours.

In the case of polyamide synthesis the ratio of amine functional groups of the polyamine is generally selected to be about 1:1 in relation to carboxylic acid groups of the polycarboxylic acid or to acid chloride groups of the polycarboxylic acid chloride or to the combination of carboxylic acid groups and acid chloride groups of the mixed polycarboxylic acid/acid chloride.

In the case of polyimide synthesis the ratio of amine groups of the polyamine is generally selected to be about 1:1 in relation to acid anhydride groups of the polycarboxylic acid anhydride.

In the case of polyamideimide synthesis the ratio of amine functional groups is generally selected to be about 1:1 in relation to the combination of acid chloride groups and acid anhydride groups of the polycarboxylic acid chloride anhydride.

### EXAMPLES

### Example 1: Hydrothermal Polymerization of 3,3′,4,4′-Biphenyltetracarboxylic Dianhydride (BTD) and 4,4′-Oxydianiline

3,3′,4,4′-biphenyltetracarboxylic dianhydride (BTD) (0.50 g, 0.00169 mol, MW 294.72, mp 299-305° C., 1 eq.) and 4,4′-oxydianiline ((0.340 g, 0.00169 mol, MW: 200.74, mp 188-192° C., 1 eq.) in 4 ml water were charged to a PTFE-lined steel hydrothermal PARR autoclave reactor. The autoclave was placed in a rotating heating oven at 200° C. for 18 h after which time it was cooled to room temperature. The precipitated product was isolated by washing with acetone and water. The material was dried in a vacuum oven at 60° C. overnight. The final polyimide product was characterized by FT-IR and TGA. Yield=0.634 g.

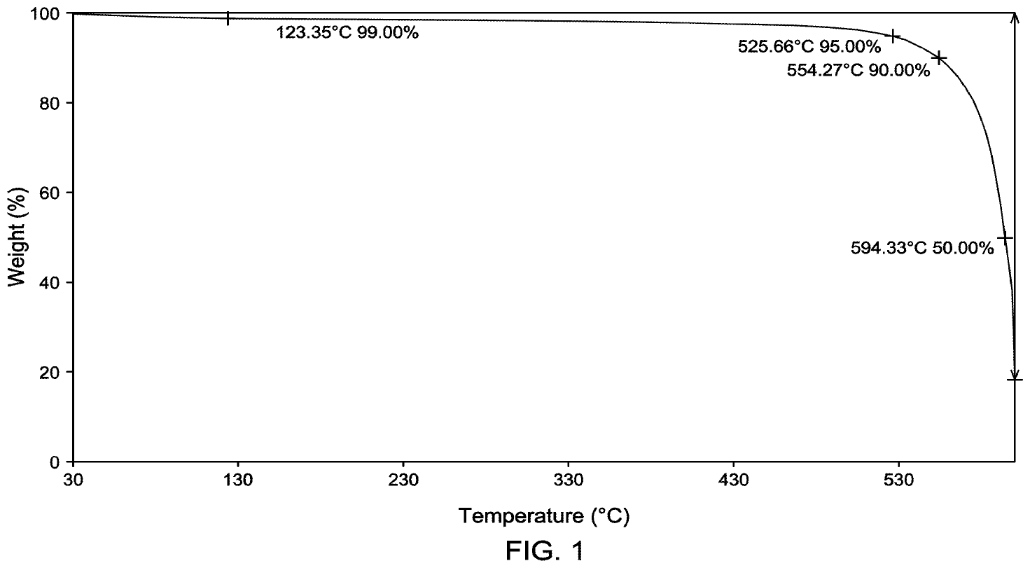

FIG. 1 illustrates the thermogravimetric analysis (TGA) of the product polyimide. The analysis indicates the polymer to be very stable with only 10% weight loss (T₁₀) at 554° C.

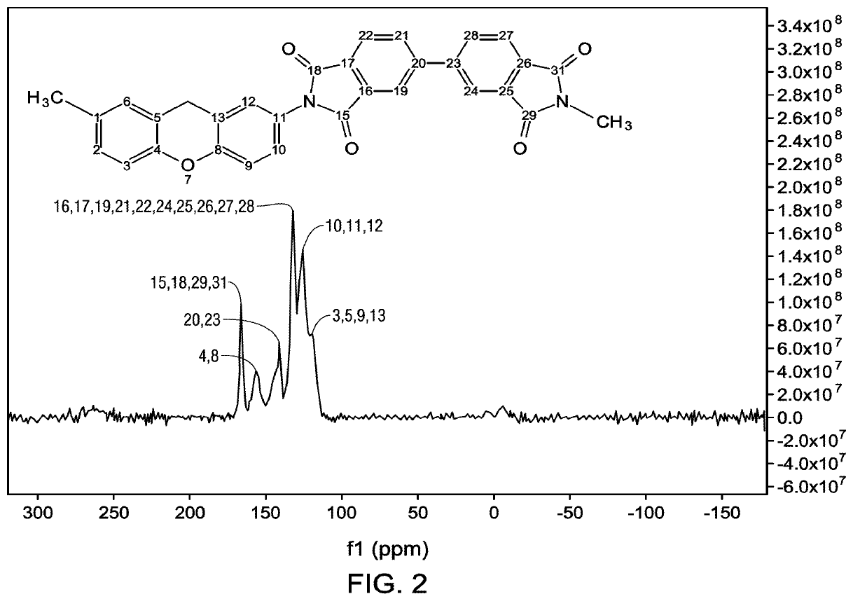

FIG. 2 illustrates the solid state 13C NMR spectrum of the product polyimide.

### Example 2: Hydrothermal Polymerization of Mellitic Acid and p-Phenylenediamine

Mellitic acid (MA) (0.50 g, 0.00146 mol, MW 342.17, 1 eq.) and p-phenylenediamine (0.473 g, 0.00428 mol, MW 108.14, 3 eq.) in 4 ml water were charged to a PTFE-lined steel hydrothermal autoclave reactor. The autoclave was placed in a sand bath at 200° C. for 18 h after which time the autoclave was cooled to room temperature. The precipitated product was isolated by washing with acetone and water. The material was dried in a vacuum oven at 60° C. overnight. The final cross-linked polyimide product was characterized by FT-IR. Yield=0.6 g.

### Example 3: Hydrothermal Polymerization of 3,3′,4,4′-Biphenyltetracarboxylic Dianhydride (BTD) and p-Phenylenediamine

3,3′,4,4′-biphenyltetracarboxylic dianhydride (BTD) (0.50 g, 0.00169 mol, MW: 294.72, 1 eq.), and p-phenylenediamine (0.183 g, 0.00169 mol, MW: 108.14, 1 eq.) in 4 ml water were charged to a PTFE-lined steel hydrothermal PARR autoclave reactor. The autoclave was placed in a rotating heating oven at 200° C. for 18 h after which time the autoclave was cooled to room temperature. The precipitated product was isolated by washing with acetone and water. The material was dried in a vacuum oven at 60° C. overnight. The final polyimide product was characterized by TGA. Yield=0.545 g.

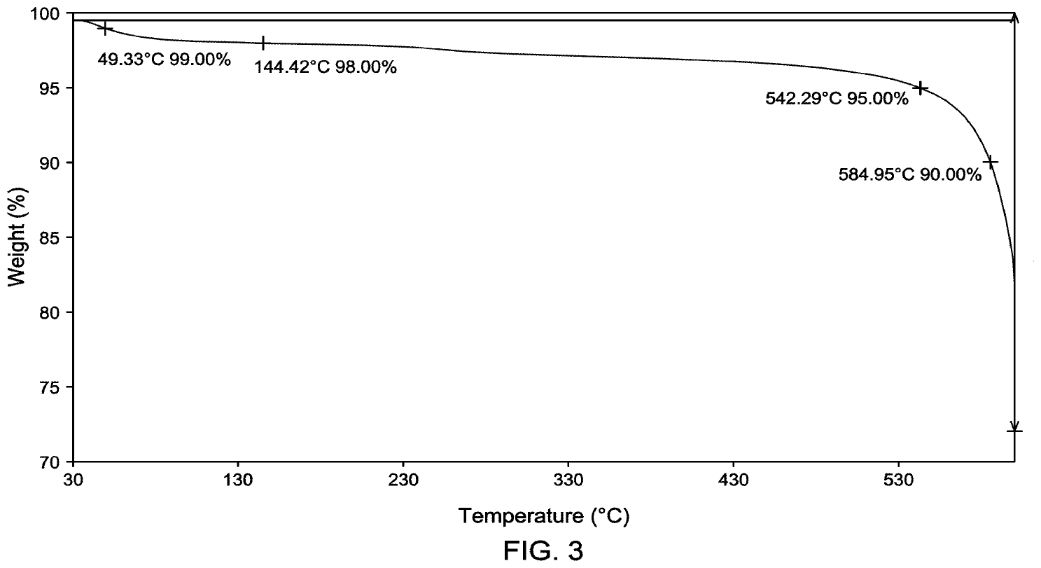

FIG. 3 illustrates the thermogravimetric analysis (TGA) of the product polyimide. The analysis indicates the polymer to be very stable with only 10% weight loss (T₁₀) at 584° C.

### Example 4: Hydrothermal Polymerization of 3,3′,4,4′-Biphenyltetracarboxylic Dianhydride (BTD) and Mixed (Para-, Ortho-, Metaphenylenediamine)

3,3′,4,4′-biphenyltetracarboxylic dianhydride (BTD) (0.50 g, 0.00169 mol, MW: 294.72, 1 eq.), and o, m, p-phenylenediamine mixture (0.183. g, 0.00169 mol, MW: 108.14, 1 eq) in 4 ml water were charged to a PTFE-lined steel hydrothermal PARR autoclave reactor. The autoclave was placed in a rotating heating oven at 200° C. temperature for 18 h after which time the autoclave was cooled to room temperature. The precipitated product was isolated by washing with acetone and water. The material was dried in a vacuum oven at 60° C. overnight. The final polyimide product was characterized by TGA. Yield=0.500 g.

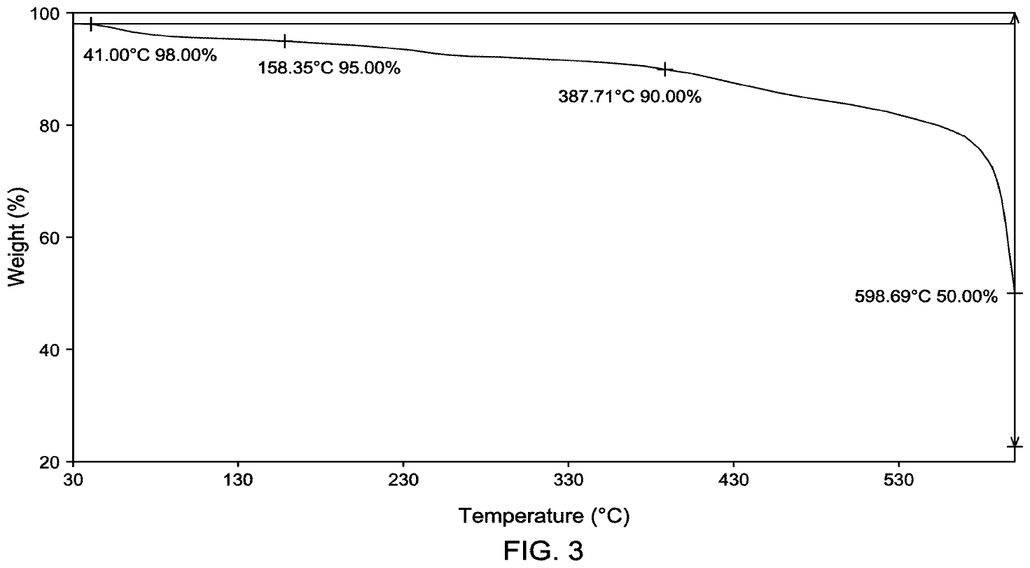

FIG. 4 illustrates the thermogravimetric analysis (TGA) of the product polyimide. The analysis indicates the polymer to have lower thermal stability (10% weight loss (T₁₀) at 388° C.) compared to the single isomer based product of Example 3.

### Example 5: Hydrothermal Polymerization of 3,3′,4,4′-Biphenyl Tetracarboxylic Dianhydride (BTD), Pyromellitic Dianhydride and 1,5-Diaminonaphthalene

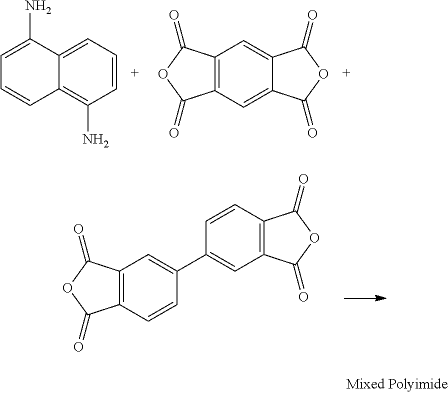

3,3′,4,4′-biphenyl tetracarboxylic dianhydride (0.147 g, 0.0005 mol, MW: 294.72, 0.5 eq), and pyromellitic dianhydride (0.109 g, 0.0005 mol, MW:218.12), 1,5-diamino naphthalene, (0.158 g, 0.0005 mol, MW: 158.20, 0.5 eq) in 7 ml water were charging in PTFE-lined steel hydrothermal PARR autoclave reactor. The autoclave was placed in a rotating heating oven at 210° C. for 18 h after which time the autoclave was cooled to room temperature. The precipitated product was isolated by washing with methanol, acetone and water. The material was dried in a vacuum oven at 60° C. overnight. The final polyimide product was characterized by TGA. Yield=0.3 g.

### Example 6: Hydrothermal Polymerization of 1,4-Terephthaloyl Chloride and 1,5-Diamino Naphthalene

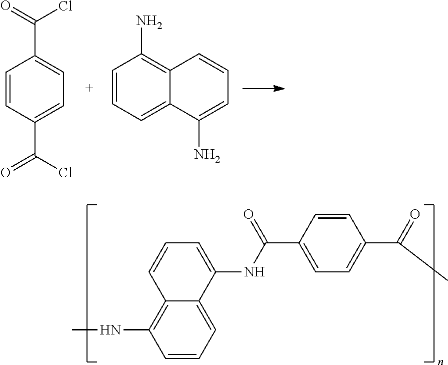

1,4-terephthaloyl chloride (0.203 g, 0.0001 mol, MW: 203.02, 1 eq), and 1,5-diamino naphthalene, (0.158 g, 0.0001 mol, MW: 158.20, 1 eq) in 5 ml water were changed in PTFE-lined steel hydrothermal PARR autoclave reactor. The autoclave placed in sand bath at 210° C. for 18 h after which time the autoclave was cooled to room temperature. The precipitated product was isolated by washing with methanol, acetone and water. The material was dried in a vacuum oven at 60° C. overnight. The final polyamide product was characterized by FT-IR. Yield=0.240 g. IR (cm-1): 2953, 2953, 2924, 1689, 1643, 1532, 1489, 1424, 1284.

### Certain Embodiments

Certain embodiments of methods according to the present disclosure are presented in the following paragraphs.

Embodiment 1 provides a method for preparing a polymer, said polymer being selected from the group consisting of mixed polyamide, mixed polyimide and mixed polyamideimide, the method comprising:
(a) contacting two or more polycarboxylic acids, polycarboxylic acid chlorides or mixed polycarboxylic acids/acid chlorides, two or more polycarboxylic acid anhydrides, or two or more polycarboxylic acid chloride anhydrides, with one or more polyamines; or
(b) contacting two or more polyamines with one or more polycarboxylic acids, polycarboxylic acid chlorides or mixed polycarboxylic acids/acid chlorides, one or more polycarboxylic acid anhydrides, or one or more polycarboxylic acid chloride anhydrides; or
(c) contacting two or more polycarboxylic acids, polycarboxylic acid chlorides or mixed polycarboxylic acids/acid chlorides, two or more polycarboxylic acid anhydrides, or two or more polycarboxylic acid chloride anhydrides, with two or more polyamines;
   wherein the contacting occurs under hydrothermal conditions effective to form a mixed polyamide, mixed polyimide or mixed polyamideimide; and
   wherein, independently, the two or more polycarboxylic acids, polycarboxylic acid chlorides or mixed polycarboxylic acids/acid chlorides, two or more polycarboxylic acid anhydrides, two or more polycarboxylic acid chloride anhydrides, or two or more polyamines, have different molecular formulae or are structural isomers.

Embodiment 2 provides a method according to embodiment 1, wherein the polycarboxylic acids, polycarboxylic acid chlorides, mixed polycarboxylic acids/acid chlorides, polycarboxylic acid anhydrides or polycarboxylic acid chloride anhydrides are aromatic polycarboxylic acids, aromatic polycarboxylic acid chlorides, aromatic mixed polycarboxylic acids/acid chlorides, aromatic polycarboxylic acid anhydrides or aromatic polycarboxylic acid chloride anhydrides.

Embodiment 3 provides a method according to embodiment 1 or embodiment 2, wherein the polyamines are aromatic polyamines.

Embodiment 4 provides a method according to any one of embodiments 1 to 3, wherein the polymer is a mixed polyamide and the method comprises:
(a) contacting two or more polycarboxylic acids, polycarboxylic acid chlorides or mixed polycarboxylic acids/acid chlorides, with one or more polyamines; or
(b) contacting two or more polyamines with one or more polycarboxylic acids, polycarboxylic acid chlorides or mixed polycarboxylic acids/acid chlorides; or
(c) contacting two or more polycarboxylic acids, polycarboxylic acid chlorides or mixed polycarboxylic acids/acid chlorides, with two or polyamines;
   wherein the contacting occurs under hydrothermal conditions effective to form the mixed polyamide; and
   wherein, independently, the two or more polycarboxylic acids, polycarboxylic acid chlorides or mixed polycarboxylic acids/acid chlorides, or the two or more polyamines, have different molecular formulae or are structural isomers.

Embodiment 5 provides a method according to any one of embodiments 1 to 3, wherein the polymer is a mixed polyimide and the method comprises:
(a) contacting two or more polycarboxylic acid anhydrides with one or more polyamines; or
(b) contacting two or more polyamines with one or more polycarboxylic acid anhydrides; or
(c) contacting two or more polycarboxylic acid anhydrides with two or more polyamines;
   wherein the contacting occurs under hydrothermal conditions effective to form the mixed polyimide; and
   wherein, independently, the two or more polycarboxylic acid anhydrides, or the two or more polyamines, have different molecular formulae or are structural isomers.

Embodiment 6 provides a method according to any one of embodiments 1 to 3, wherein the polymer is a mixed polyamideimide and the method comprises:
(a) contacting two or more polycarboxylic acid chloride anhydrides with one or more polyamines; or
(b) contacting two or more polyamines with one or more polycarboxylic acid chloride anhydrides; or
(c) contacting two or more polycarboxylic acid chloride anhydrides with two or more polyamines;
   wherein the contacting occurs under hydrothermal conditions effective to form the mixed polyamideimide; and
   wherein, independently, the two or more polycarboxylic acid chloride anhydrides, or the two or more polyamines, have different molecular formulae or are structural isomers.

Embodiment 7 provides a method according to any one of embodiments 1 to 4, wherein the polycarboxylic acids are dicarboxylic acids.

Embodiment 8 provides a method according to any one of embodiments 1 to 4, wherein the polycarboxylic acid chlorides are dicarboxylic acid chlorides.

Embodiment 9 provides a method according to any one of embodiments 1 to 4, wherein the mixed polycarboxylic acids/acid chlorides are mixed dicarboxylic acids/acid chlorides.

Embodiment 10 provides a method according to any one of embodiments 1 to 3 and 5, wherein the polycarboxylic acid anhydrides are tetracarboxylic acids dianhydrides.

Embodiment 11 provides a method according to any one of embodiments 1 to 3 and 6, wherein the polycarboxylic acid chloride anhydrides are dicarboxylic acid chloride anhydrides.

Embodiment 12 provides a method according to any one of embodiments 1 to 11, wherein the polyamines are diamines.

Embodiment 13 provides a method according to any one of embodiments 1 to 12, wherein the two or more polycarboxylic acids, or two or more polycarboxylic acid chlorides, or two or more mixed polycarboxylic acids/acid chlorides, or two or more polycarboxylic acid anhydrides, or two or more polycarboxylic acid chloride anhydrides, are structural isomers.

Embodiment 14 provides a method according to any one of embodiments 1 to 13, wherein the two or more polyamines are structural isomers.

Embodiment 15 provides a method according to any one of embodiments 1 to 12 or 14, wherein the two or more polycarboxylic acids, or two or more polycarboxylic acid chlorides, or the two or more mixed polycarboxylic acids/acid chlorides, or two or more polycarboxylic acid anhydrides, or two or more polycarboxylic acid chloride anhydrides, have different molecular formulae.

Embodiment 16 provides a method according to any one of embodiments 1 to 13 or 15, wherein the two or more polyamines have different molecular formulae.

Embodiment 17 provides a method according to any one of embodiments 1 to 16, wherein the two or more polyamines are not structural isomers of phenylene diamine.

Embodiment 18 provides a method according to any one of embodiments 1 to 17, wherein the polymer is a linear mixed polyamide, a linear mixed polyimide or a linear mixed polyamideimide.

Embodiment 19 provides a method according to any one of embodiments 1 to 17, wherein the polymer is cross-linked mixed polyamide, a cross-linked mixed polyimide or a cross-linked mixed polyamideimide.

Embodiment 20 provides a method according to any one of embodiments 1 to 4, 7 or 12 to 19, wherein the polycarboxylic acid has the general formula:

Ar(COOH)n

wherein Ar represents aryl or substituted aryl and n is an integer greater than or equal to 2.

Embodiment 21 provides a method according to embodiment 20, wherein Ar is selected from the group consisting of an optionally substituted single aromatic ring and optionally substituted multiple aromatic rings which are fused together, directly linked, or indirectly linked through one or more linking groups.

Embodiment 22 provides a method according to embodiment 20, wherein Ar is an optionally substituted polyaromatic hydrocarbon or an optionally substituted polyheterocyclic.

Embodiment 23 provides a method according to embodiment 20, wherein the carboxylate substituents are on the same or different rings of Ar.

Embodiment 24 provides a method according to any one of embodiments 1 to 4, 8 or 12 to 19, wherein the polycarboxylic acid chloride has the general formula:

Ar(COCl)n

wherein Ar represents aryl or substituted aryl and n is an integer greater than or equal to 2.

Embodiment 25 provides a method according to embodiment 24, wherein Ar is selected from the group consisting of an optionally substituted single aromatic ring and optionally substituted multiple aromatic rings which are fused together, directly linked, or indirectly linked through one or more linking groups.

Embodiment 26 provides a method according to embodiment 24, wherein Ar is an optionally substituted polyaromatic hydrocarbon or an optionally substituted polyheterocyclic.

Embodiment 27 provides a method according to embodiment 24, wherein the acid chloride substituents are on the same or different rings of Ar.

Embodiment 28 provides a method according to any one of embodiments 1 to 4, 9 or 12 to 19, wherein the mixed polycarboxylic acid/acid chloride has the general formula:

Ar(COOH)m(COCl)n

wherein Ar represents aryl or substituted aryl and both m and n are integers greater than or equal to 1.

Embodiment 29 provides a method according to embodiment 28, wherein Ar is selected from the group consisting of an optionally substituted single aromatic ring and optionally substituted multiple aromatic rings which are fused together, directly linked, or indirectly linked through one or more linking groups.

Embodiment 30 provides a method according to embodiment 28, wherein Ar is an optionally substituted polyaromatic hydrocarbon or an optionally substituted polyheterocyclic.

Embodiment 31 provides a method according to embodiment 28, wherein the carboxylic acid and acid chloride substituents are on the same or different rings of Ar.

Embodiment 32 provides a method according to any one of embodiments 1 to 3, 5, 10 or 12 to 19, wherein the polycarboxylic acid anhydride has the general formula:

Ar(COOCO)m

wherein Ar represents aryl or substituted aryl and m is an integer greater than or equal to 2.

Embodiment 33 provides a method according to embodiment 32, wherein Ar is selected from the group consisting of an optionally substituted single aromatic ring and optionally substituted multiple aromatic rings which are fused together, directly linked, or indirectly linked through one or more linking groups.

Embodiment 34 provides a method according to embodiment 32, wherein Ar is an optionally substituted polyaromatic hydrocarbon or an optionally substituted polyheterocyclic.

Embodiment 35 provides a method according to embodiment 32, wherein the acid anhydride substituents are on the same or different rings of Ar.

Embodiment 36 provides a method according to any one of embodiments 1 to 3, 6 or 11 to 19, wherein the polycarboxylic acid chloride anhydride has the general formula:

Ar(COOCO)m(COCl)n

wherein Ar represents aryl or substituted aryl and both n and m are integers greater than or equal to 1.

Embodiment 37 provides a method according to embodiment 36, wherein Ar is selected from the group consisting of an optionally substituted single aromatic ring and optionally substituted multiple aromatic rings which are fused together, directly linked, or indirectly linked through one or more linking groups.

Embodiment 38 provides a method according to embodiment 36, wherein Ar is an optionally substituted polyaromatic hydrocarbon or an optionally substituted polyheterocyclic.

Embodiment 39 provides a method according to embodiment 36, wherein the acid anhydride substituents and acid chloride substituents are, independently, on the same or different rings of Ar.

Embodiment 40 provides a method according to any one of embodiments 1 to 39, wherein the polyamine has the general formula:

Ar(NH₂)p

wherein Ar represents aryl or substituted aryl and p is an integer greater than or equal to 2.

Embodiment 41 provides a method according to embodiment 40, wherein Ar is selected from the group consisting of an optionally substituted single aromatic ring and optionally substituted multiple aromatic rings which are fused together, directly linked, or indirectly linked through one or more linking groups.

Embodiment 42 provides a method according to embodiment 40, wherein Ar is an optionally substituted polyaromatic hydrocarbon or an optionally substituted polyheterocyclic.

Embodiment 43 provides a method according to embodiment 40, wherein the amine substituents are on the same or different rings of Ar.

Embodiment 44 provides a method according to any one of embodiments 1 to 43, wherein the polyamines are selected from the group consisting of p-phenylenediamine, m-phenylenediamine, o-phenylenediamine, 2,4,6-trimethyl-m-phenylenediamine, naphthalene-1,4-diamine, naphthalene-2,3-diamine, naphthalene-1,2-diamine, naphthalene-1,5-diamine, naphthalene-1,8-diamine, phenanthrene-9,10-diamine, 4-methylbenzene-1,3-diamine, 2-methylbenzene-1,3-diamine, 3-methylbenzene-1,2-diamine, 4-methylbenzene-1,2-diamine, 4,5-dimethylbenzene-1,2-diamine, 4,5-dimethylbenzene-1,3-diamine, 3,4-dimethylbenzene-1,2-diamine, 2,3-dimethylbenzene-1,4-diamine, 2,5-dimethylbenzene-1,3-diamine, 2,5-dimethylbenzene-1,4-diamine, 6-dimethylbenzene-1,2-diamine, 4,6-dimethylbenzene-1,3-diamine, 2,4-dimethylbenzene-1,3-diamine, 2,3,5,6-tetramethyl-p-phenylenediamine, 4,4′-oxydianiline, 4,4′-(hexafluoroisopropydene)dianiline, 5,5′-(hexafluoroisopropydene)o-toluidine, 4,4′-(hexafluoroisopropydene)bis(p-phenyleneoxy)dianiline, 4,4′-(1,4-phenylenediisopropylidene)bisaniline, 4,4′-(1,3-phenylenedioxy)dianiline, 4,4′-(1,1′-biphenyl-4,4′-diyldioxy)dianiline, and 4,4′-diaminooctafluorobiphenyl.

Embodiment 45 provides a method according to any one of embodiments 1, 4, 7 or 12 to 23, wherein the polycarboxylic acids are selected from the group consisting of phthalic acid, isophthalic acid, terephthalic acid, naphthalene-1,4-dicarboxylic acid, naphthalene-2,3-dicarboxylic acid, naphthalene-2,6-dicarboxylic acid, [1,1-biphenyl]-4,4′-dicarboxylic acid, [1,1-biphenyl]-2,2′-dicarboxylic acid, 4,4′-oxydibenzoic acid, 4,4′-sulfonyldibenzoic acid, 4,4′-(hexafluoroisopropylidene)bis(benzoic acid), 4,4′ sulfonyldibenzoic acid, mellitic acid, 1,1-binaphthyl-8,8-dicarboxylic acid and 1,2,4,5-benzenetetracarboxylic acid.

Embodiment 46 provides a method according to any one of embodiments 1 to 4, 8, 12 to 19 or 24 to 27, wherein the polycarboxylic acid chlorides are selected from the group consisting of isophthaloyl chloride, phthaloyl chloride, terephthaloyl chloride, 1,3,5-benzene tricarbonyl trichloride, naphthalene-1,4-dicarbonyl dichloride, naphthalene-2,6-dicarbonyl dichloride, naphthalene-2,3-dicarbonyl dichloride, naphthalene-1,8-dicarbonyl dichloride, [1,1′-biphenyl]-2,2′-dicarbonyl dichloride, and [1,1′-biphenyl]-4,4′-dicarbonyl dichloride.

Embodiment 47 provides a method according to any one of embodiments 1 to 3, 5, 10, 12 to 19 or 32 to 35, wherein the polycarboxylic acid anhydrides are selected from the group consisting of pyromellitic dianhydride (benzene-1,2,4,5-tetracarboxylic dianhydride), 3,3′,4,4′-biphenyltetracarboxylic dianhydride, 4,4′-oxydiphthalic anhydride, 4,4′-(hexafluoroisopropylidene)diphthalic anhydride, 4,4′(4,4′-isopropylidenediphenoxy)bis(phthalic anhydride) 1,4,5,8-naphthalene tetracarboxylic dianhydride, perylene-3,4,9,10-tetracarboxylic dianhydride, 1,4,5,8-naphthalene tetracarboxylic dianhydride, bicycle(2,2,2)oct-7-ene-2,3,5,6-tetracarboxylic dianhydride, 4,4′-(4,4′-isopropylidenediphenoxy)bis (phthalic anhydride) and benzophenone-3,3′,4,4′-biphenyltetracarboxylic dianhydride.

Embodiment 48 provides a method according to any one of embodiments 1 to 3, 6, 11 to 19 or 36 to 39, wherein the polycarboxylic acid chloride anhydrides are selected from the group consisting of trimellitic acid chloride, 4-(1,3-dioxo-1,3-dihydroisobenzofuran-5-yl)benzoyl chloride, 4′-(chlorocarbonyl)[1,1′-biphenyl]-4-carboxylic acid, 4′-(chlorocarbonyl)-[1,1′-biphenyl]-4-carboxylic acid, 1,3-dioxo-1,3-dihydronaphtho[1,2-c]furan-7-carbonyl chloride, and 6-(chlorocarbonyl)naphthalene-1,2-dicarboxylic acid.

Embodiment 49 provides a method according to any one of embodiments 1 to 48, wherein the two or more polyamines are structural isomers of naphthalenediamine or biphenyldiamine.

Embodiment 50 provides a method according to any one of embodiments 1 to 49, wherein the two or more polycarboxylic acids are structural isomers of phenylenedicarboxylic acid, naphthalenedicarboxylic acid, or biphenyldicarboxylic acid.

Embodiment 51 provides a method according to any one of embodiments 1 to 50, wherein the contacting occurs from about 150 to about 250° C.

Embodiment 52 provides a method according to any one of embodiments 1 to 51, wherein the contacting is performed for about 30 minutes to about 48 hours.

Embodiment 53 provides a mixed polyamide obtained by the method according to any one of embodiments 1 to 52.

Embodiment 54 provides a mixed polyimide obtained by the method according to any one of embodiments 1 to 52.

Embodiment 55 provides a mixed polyamideimide obtained by the method according to any one of embodiments 1 to 52.

Embodiment 56 provides a polymer obtained by the method according to any one of embodiments 1 to 52, wherein the polymer is thermoplastic.

Embodiment 57 provides a polymer obtained by the method according to any one of embodiments 1 to 52, wherein the polymer is thermoset.

Embodiment 58 provides an article of manufacture comprising one or more polymers obtained by the method according to any one of embodiments 1 to 52.

Embodiment 59 provides an article of manufacture according to embodiment 58, wherein the article is automotive engine parts, electric and electronic components, films, fibers, components in infrastructure applications, both load or non-load bearing, such as, for example, beams, columns and panels.

Embodiment 60 provides a composite comprising one or more polymers obtained by the method according to any one of embodiments 1 to 52 and at least one other material.

All patents, patent applications and other documents cited herein are fully incorporated by reference to the extent such disclosure is not inconsistent with this disclosure and for all jurisdictions in which such incorporation is permitted.

Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present disclosure will be apparent from the appended claims. Moreover, those skilled in the art will recognize, or be able to ascertain using no more than routine experimentation, many equivalents to the specific embodiments of the disclosure described herein. Such equivalents are intended to be encompassed by the following claims.

1. A method for preparing a polymer, said polymer being selected from the group consisting of mixed polyamide, mixed polyimide and mixed polyamideimide, the method comprising:
(a) contacting two or more polycarboxylic acids, polycarboxylic acid chlorides or mixed polycarboxylic acids/acid chlorides, two or more polycarboxylic acid anhydrides, or two or more polycarboxylic acid chloride anhydrides, with one or more polyamines; or
(b) contacting two or more polyamines with one or more polycarboxylic acids, polycarboxylic acid chlorides or mixed polycarboxylic acids/acid chlorides, one or more polycarboxylic acid anhydrides, or one or more polycarboxylic acid chloride anhydrides; or
(c) contacting two or more polycarboxylic acids, polycarboxylic acid chlorides or mixed polycarboxylic acids/acid chlorides, two or more polycarboxylic acid anhydrides, or two or more polycarboxylic acid chloride anhydrides, with two or more polyamines;
wherein the contacting occurs under hydrothermal conditions effective to form a mixed polyamide, mixed polyimide or mixed polyamideimide; and
wherein, independently, the two or more polycarboxylic acids, polycarboxylic acid chlorides or mixed polycarboxylic acids/acid chlorides, two or more polycarboxylic acid anhydrides, two or more polycarboxylic acid chloride anhydrides, or two or more polyamines, have different molecular formulae or are structural isomers.

2. A method according to claim 1, wherein the polycarboxylic acids, polycarboxylic acid chlorides, mixed polycarboxylic acids/acid chlorides, polycarboxylic acid anhydrides or polycarboxylic acid chloride anhydrides are aromatic polycarboxylic acids, aromatic polycarboxylic acid chlorides, aromatic mixed polycarboxylic acids/acid chlorides, aromatic polycarboxylic acid anhydrides or aromatic polycarboxylic acid chloride anhydrides.

3. A method according to claim 1, wherein the polyamines are aromatic polyamines.

4. A method according to claim 1, wherein the polymer is a mixed polyamide and the method comprises:
(a) contacting two or more polycarboxylic acids, polycarboxylic acid chlorides or mixed polycarboxylic acids/acid chlorides, with one or more polyamines; or
(b) contacting two or more polyamines with one or more polycarboxylic acids, polycarboxylic acid chlorides or mixed polycarboxylic acids/acid chlorides; or
(c) contacting two or more polycarboxylic acids, polycarboxylic acid chlorides or mixed polycarboxylic acids/acid chlorides, with two or polyamines;
wherein the contacting occurs under hydrothermal conditions effective to form the mixed polyamide; and
wherein, independently, the two or more polycarboxylic acids, polycarboxylic acid chlorides or mixed polycarboxylic acids/acid chlorides, or the two or more polyamines, have different molecular formulae or are structural isomers.

5. A method according to claim 1, wherein the polymer is a mixed polyimide and the method comprises:
(a) contacting two or more polycarboxylic acid anhydrides with one or more polyamines; or
(b) contacting two or more polyamines with one or more polycarboxylic acid anhydrides; or
(c) contacting two or more polycarboxylic acid anhydrides with two or more polyamines;
wherein the contacting occurs under hydrothermal conditions effective to form the mixed polyimide; and
wherein, independently, the two or more polycarboxylic acid anhydrides, or the two or more polyamines, have different molecular formulae or are structural isomers.

6. A method according to claim 1, wherein the polymer is a mixed polyamideimide and the method comprises:
(a) contacting two or more polycarboxylic acid chloride anhydrides with one or more polyamines; or
(b) contacting two or more polyamines with one or more polycarboxylic acid chloride anhydrides; or
(c) contacting two or more polycarboxylic acid chloride anhydrides with two or more polyamines;
wherein the contacting occurs under hydrothermal conditions effective to form the mixed polyamideimide; and
wherein, independently, the two or more polycarboxylic acid chloride anhydrides, or the two or more polyamines, have different molecular formulae or are structural isomers.

7. A method according to claim 1, wherein the polycarboxylic acids are dicarboxylic acids.

8. A method according to claim 1, wherein the polycarboxylic acid chlorides are dicarboxylic acid chlorides.

9. A method according to claim 1, wherein the mixed polycarboxylic acids/acid chlorides are mixed dicarboxylic acids/acid chlorides.

10. A method according to claim 1, wherein the polycarboxylic acid anhydrides are tetracarboxylic acids dianhydrides.

11. A method according to claim 1, wherein the polycarboxylic acid chloride anhydrides are dicarboxylic acid chloride anhydrides.

12. A method according to claim 1, wherein the polyamines are diamines.

13. A method according to claim 1, wherein the two or more polycarboxylic acids, or two or more polycarboxylic acid chlorides, or the two or more mixed polycarboxylic acids/acid chlorides, or two or more polycarboxylic acid anhydrides or two or more polycarboxylic acid chloride anhydrides, are structural isomers.

14. A method according to claim 1, wherein the two or more polyamines are structural isomers.

15. A method according to claim 1, wherein the two or more polycarboxylic acids, or two or more polycarboxylic acid chlorides, or the two or more mixed polycarboxylic acids/acid chlorides, or two or more polycarboxylic acid anhydrides, or two or more polycarboxylic acid chloride anhydrides, have different molecular formulae.

16. A method according to claim 1, wherein the two or more polyamines have different molecular formulae.

17. A method according to claim 1, wherein the two or more polyamines are not structural isomers of phenylene diamine.

18. A method according to claim 1, wherein the polymer is a linear mixed polyamide, a linear mixed polyimide or a linear mixed polyamideimide.

19. A method according to claim 1, wherein the polymer is cross-linked mixed polyamide, a cross-linked mixed polyimide or a cross-linked mixed polyamideimide.

20. A method according to claim 1, wherein the polycarboxylic acid has the general formula:
Ar(COOH)ₙ
wherein Ar represents aryl or substituted aryl and n is an integer greater than or equal to 2.

21.-23. (canceled)

24. A method according to claim 1, wherein the polycarboxylic acid chloride has the general formula:
Ar(COCl)ₙ
wherein Ar represents aryl or substituted aryl and n is an integer greater than or equal to 2.

25-27. (canceled)

28. A method according to claim 1, wherein the mixed polycarboxylic acid/acid chloride has the general formula:
Ar(COOH)ₘ(COCl)ₙ
wherein Ar represents aryl or substituted aryl and both m and n are integers greater than or equal to 1.

29.-31. (canceled)

32. A method according to claim 1, wherein the polycarboxylic acid anhydride has the general formula:
Ar(COOCO)ₘ
wherein Ar represents aryl or substituted aryl and m is an integer greater than or equal to 2.

33.-35. (canceled)

36. A method according to claim 1, wherein the polycarboxylic acid chloride anhydride has the general formula:
Ar(COOCO)ₘ(COCl)ₙ
wherein Ar represents aryl or substituted aryl and both n and m are integers greater than or equal to 1.

37-60. (canceled)
